(19) United States
(12) Patent Application Publication
(10) Pub. No.: US 2024/0147492 A1
(43) Pub. Date: May 2, 2024

(54) METHODS, DEVICES AND COMPUTER STORAGE MEDIA FOR COMMUNICATION

(71) Applicant: NEC CORPORATION, Tokyo (CN)

(72) Inventors: Yukai GAO, Beijing (CN); Gang WANG, Beijing (CN)

(73) Assignee: NEC CORPORATION, Tokyo (CN)

(21) Appl. No.: 18/279,011

(22) PCT Filed: Feb. 26, 2021
(86) PCT No.: PCT/CN2021/078252

§ 371 Date: Aug. 25, 2023

(51) Int. Cl. H04W 72/232; H04W 72/0446; H04W 72/0457

(52) U.S. Cl. CPC H04W 72/232; H04W 72/0446; H04W 72/0457

(57) ABSTRACT

Embodiments of the present disclosure relate to methods, devices and computer storage media for communication. A method comprises monitoring, at a terminal device, a first Physical Downlink Control Channel (PDCCH) candidate and a second PDCCH candidate, wherein the first PDCCH candidate and the second PDCCH candidate are linked for PDCCH repetition. The method further comprises in response to a predetermined condition being satisfied, detecting, from at least one of the first and second PDCCH candidates, downlink control information (DCI) comprising a bandwidth part (BWP) indicator field indicating an active BWP change.

### TECHNICAL FIELD

Embodiments of the present disclosure generally relate to the field of telecommunication, and in particular, to methods, devices and computer storage media for communication.

### BACKGROUND

Recently, enhancements on the support for multi-Transmission and Reception Point (multi-TRP) deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline.

Downlink control information (DCI) can be transmitted from a network device to a terminal device (such as, UE) via a PDCCH. A DCI format may include a bandwidth part (BWP) indicator field indicating an active uplink (UL) or downlink (DL) BWP change. If PDCCH repetition is enabled, DCI can be transmitted from a network device to a terminal device via linked PDCCH candidates. If linked PDCCH candidates are used to carry DCI indicating an active BWP change, the UE behaviors need to be considered.

### SUMMARY

In general, example embodiments of the present disclosure provide methods, devices and computer storage media for communication.

In a first aspect, there is provided a method of communication. The method comprises monitoring, at a terminal device, a first Physical Downlink Control Channel (PDCCH) candidate and a second PDCCH candidate, wherein the first PDCCH candidate and the second PDCCH candidate are linked for PDCCH repetition; and in response to a predetermined condition being satisfied, detecting, from at least one of the first and second PDCCH candidates, downlink control information (DCI) comprising a bandwidth part (BWP) indicator field indicating an active BWP change.

In a second aspect, there is provided a method of communication. The method comprises monitoring, at a terminal device, a first Physical Downlink Control Channel (PDCCH) candidate and a second PDCCH candidate, wherein the first PDCCH candidate and the second PDCCH candidate are linked for PDCCH repetition; and detecting downlink control information (DCI) from at least one of the first and second PDCCH candidates, wherein the DCI comprises no indication of an active bandwidth part (BWP) change.

In a third aspect, there is provided a method of communication. The method comprises transmitting, from a network device to a terminal device, downlink control information (DCI) via a first Physical Downlink Control Channel (PDCCH) candidate and a second PDCCH candidate, wherein the first PDCCH candidate and the second PDCCH candidate are linked for PDCCH repetition and the DCI comprises a bandwidth part (BWP) indicator field indicating an active BWP change.

In a fourth aspect, there is provided a method of communication. The method comprises transmitting, from a network device to a terminal device, downlink control information (DCI) via a first Physical Downlink Control Channel (PDCCH) candidate and a second PDCCH candidate, wherein the first PDCCH candidate and the second PDCCH candidate are linked for PDCCH repetition and the DCI comprises no active bandwidth part (BWP) switching indication.

In a fifth aspect, there is provided a terminal device. The terminal device comprises circuitry configured to perform the method according to the above first or second aspect of the present disclosure.

In a sixth aspect, there is provided a network device. The network device comprises circuitry configured to perform the method according to the above third or fourth aspect of the present disclosure.

In a seventh aspect, there is provided a computer program product that is stored on a computer readable medium and includes machine-executable instructions. The machine-executable instructions, when being executed, cause a machine to perform the method according to the above first, second, third or fourth aspect of the present disclosure.

In an eighth aspect, there is provided a computer readable medium having instructions stored thereon. The instructions, when executed on at least one processor, causing the at least one processor to perform the method according to the above first, second, third or fourth aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a flowchart of an example method in accordance with some embodiments of the present disclosure FIGS. 3A and 3B illustrate examples of embodiments of the present disclosure;

FIGS. 4A and 4B illustrate examples of embodiments of the present disclosure;

FIGS. 5A-5C illustrate examples of embodiments of the present disclosure;

FIGS. 6A and 6B illustrate examples of embodiments of the present disclosure;

FIGS. 7A-7D illustrate examples of embodiments of the present disclosure;

FIG. 8 illustrates a flowchart of an example method in accordance with some embodiments of the present disclosure;

FIG. 9 illustrates a flowchart of an example method in accordance with some embodiments of the present disclosure;

FIG. 10 illustrates a flowchart of an example method in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

A DCI format may include a BWP indicator field indicating an active UL or DL BWP change. Regarding BWP switching, as specified in TS 38.213 of 3GPP specifications, a UE expects to detect a DCI format with a BWP indicator field that indicates an active UL BWP change or an active DL BWP change only if a corresponding PDCCH is received within the first 3 symbols of a slot. A UE does not expect to detect a DCI format with a BWP indicator field that indicates an active DL BWP or an active UL BWP change with the corresponding time domain resource assignment field providing a slot offset value for a PDSCH reception or PUSCH transmission that is smaller than a delay required by the UE for an active DL BWP change or UL BWP change, respectively. If a UE detects a DCI format with a BWP indicator field that indicates an active DL BWP change for a cell, the UE is not required to receive or transmit in the cell during a time duration from the end of the third symbol of a slot where the UE receives the PDCCH that includes the DCI format in a scheduling cell until the beginning of a slot indicated by the slot offset value of the time domain resource assignment field in the DCI format. If a UE detects a DCI format indicating an active UL BWP change for a cell, the UE is not required to receive or transmit in the cell during a time duration from the end of the third symbol of a slot where the UE receives the PDCCH that includes the DCI format in the scheduling cell until the beginning of a slot indicated by the slot offset value of the time domain resource assignment field in the DCI format. As specified in TS 38.133 of 3GPP specifications, for DCI-based BWP switching, after a UE receives a BWP switching request at DL slot n on a serving cell, the UE shall be able to receive PDSCH (for DL active BWP switch) or transmit PUSCH (for UL active BWP switch) on the new BWP on the serving cell on which BWP switch on the first DL or UL slot occurs right after a time duration of T_{BWPswitchDelay} which starts from the beginning of DL slot n. The UE is not required to transmit UL signals or receive DL signals until the first DL or UL slot occurs right after a time duration of T_{BWPswitchDelay} which starts from the beginning of DL slot n except DCI triggering BWP switching on the cell where DCI-based BWP switching occurs.

As described above, in order to improve reliability and robustness for PDCCH, Single or same DCI can be transmitted from a network device to a terminal device (such as, UE) via multiple PDCCH candidates which are linked for PDCCH repetition. If linked PDCCH candidates are used to carry DCI indicating an active BWP change, there are several problems to be solved. For example, if there are two linked PDCCH candidates for PDCCH repetition, especially in case of time division multiplexing (TDM) based PDCCH repetition, the later PDCCH candidate may end after the first 3 symbols of a slot. If both of the two PDCCH candidates should be received within the first 3 symbols of a slot for BWP switching, it is quite limited for search space/control resource set (CORESET) configuration. Moreover, if linked PDCCH candidates are used to carry DCI indicating an active BWP change, how to determine the time duration in which the UE is not required to perform transmission or reception is not clear. Further, if one of the linked PDCCH candidate overlap with the time duration in which the UE is not required to perform transmission or reception, the UE behavior is not clear.

Embodiments of the present disclosure provide a solution to solve the above problem and/or one or more of other potential problems. This solution specifies the behavior of the terminal device if linked PDCCH candidates are used to carry DCI indicating an active BWP change.

In the following, the terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs” and “repeated PDCCH signals”, “PDCCH candidates configured for same scheduling” can be used interchangeably. The terms “DCI” and “DCI format” can be used interchangeably. The terms “TCI state”, “Quasi-co-location (QCL)”, “set of QCL parameter(s)”, “QCL parameter(s)”, “QCL assumption” and “QCL configuration” can be used interchangeably.

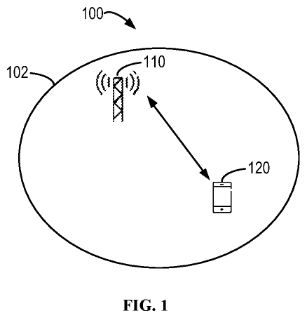

FIG. 1 illustrates an example communication network 100 in which embodiments of the present disclosure can be implemented. As shown in FIG. 1, the network 100 includes a network device 110 and a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing implementations of the present disclosure. Although not shown, it would be appreciated that one or more terminal devices may be located in the cell 102 and served by the network device 110.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In some embodiments, the network device 110 may communicate with the terminal device 120 via a first TRP and a second TRP. For example, the first TRP and the second TRP may be included in a same serving cell or different serving cells provided by the network device 110. Although some embodiments of the present disclosure are described with reference to the first and the second TRP within same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

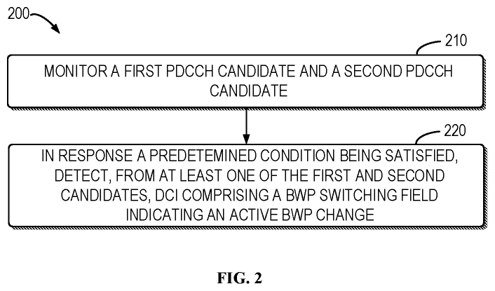

FIG. 2 illustrates a flowchart of an example method 200 in accordance with some embodiments of the present disclosure. For example, the method 200 can be implemented at the terminal device 120 as shown in FIG. 1.

At block 210, the terminal device 120 monitors a first PDCCH candidate and a second PDCCH candidate, where the first PDCCH candidate and the second PDCCH candidate are linked for PDCCH repetition.

In some embodiments, the terminal device 120 may be configured with multiple control-resource sets (i.e. CORESET).

In some embodiments, a CORESET may consist of N_{RB}^{CORESET} resource blocks (RBs) in the frequency domain and N_{symb}^{CORESET}∈{1,2,3} symbols in the time domain. In some embodiments, a control-channel element (CCE) consists of 6 resource-element groups (REGs) where a REG equals to one resource block during one orthogonal frequency-division multiplexing (OFDM) symbol. In some embodiments, REGs within a control-resource set are numbered in increasing order in a time-first manner, starting with 0 for the first OFDM symbol and the lowest-numbered resource block in the control resource set.

In some embodiments, one CORESET may be associated with one or more search space sets. One search space set may include or may be associated with one or more PDCCH candidates. In some embodiments, PDCCH monitoring periodicity and/or slot offset and/or symbol index within a slot can be configured per search space set. In some embodiments, one PDCCH candidate may be associated with or may correspond to a search space.

In some embodiments, a procedure may be defined for determining physical downlink control channel candidates for the terminal device 120. That is, determining the CCE index(es) for each of a plurality of PDCCH candidates that is potentially to be used for PDCCH transmission between the network device 110 and the terminal device 120. With the CCE index for PDCCH candidates determined, the terminal device 120 can perform blind detection on these PDCCH candidates. Once PDCCH transmission is detected or received on a PDCCH candidate, the terminal device 120 may decode it to obtain information such as DCI.

In some embodiments, the terminal device 120 may assume that a Demodulation Reference Signal (DM-RS) antenna port associated with PDCCH reception(s) in the CORESET is quasi co-located (QCLed) with the one or more reference signal (RS) configured by a transmission control indicator (TCI) state, where the TCI state is indicated for the CORESET, if any.

In some embodiments, the terminal device 120 may assume that a DM-RS antenna port associated with PDCCH reception(s) in the CORESET is quasi co-located (QCLed) with a Synchronization Signal/Physical Broadcast Channel (SS/PBCH) block the UE identified during a most recent random access procedure not initiated by a PDCCH order that triggers a contention-free random access procedure, if no Medium Access Control (MAC) control element (CE) activation command indicating a TCI state for the CORESET is received after the most recent random access procedure the one or more reference signal (RS) configured by a TCI state, where the TCI state is indicated for the CORESET, if any.

In some embodiments, the network device 110 may transmit, to the terminal device 120, a configuration indicative of N PDCCH candidates, where N is a positive integer. For example, 1≤N≤32. For another example, N=2. For example, the configuration may be transmitted via any of Radio Resource Control (RRC) signaling, Medium Access Control (MAC) control element (CE) and DCI.

In some embodiments, the network device 110 may transmit, to the terminal device 120, one or more configurations for a first PDCCH candidate and a second PDCCH candidate. In some embodiments, the first PDCCH candidate may be comprised in a first search space or a first search space set. In some embodiments, the first search space or the first search space set may be associated with a first CORESET. In some embodiments, the first CORESET may be associated or configured with a first TCI state T1 or a first set of QCL parameters Q1. In some embodiments, the second PDCCH candidate may be comprised in a second search space or a second search space set. In some embodiments, the second search space or the second search space set may be associated with a second CORESET. In some embodiments, the second CORESET may be associated or configured with a second TCI state T2 or a second set of QCL parameters Q2. In some embodiments, T1 may be different from T2. In some embodiments, Q1 may be different from Q2.

In some embodiments, the first PDCCH candidate and the second PDCCH candidate may be explicitly linked/associated together. For example, the terminal device 120 is able to know the linking/association before decoding. In some embodiments, there may be a first PDCCH/DCI transmitted/received in the first PDCCH candidate. In some embodiments, there may be a second PDCCH/DCI transmitted/received in the second PDCCH candidate. In some embodiments, the DCI payload and/or the coded bits and/or the number of CCEs in the first PDCCH/DCI are same with the second PDCCH/DCI. In some embodiments, the first PDCCH/DCI and the second PDCCH/DCI schedule a same communication between the network device 110 and the terminal device 120. For example, the communication may be at least one of PDSCH, PUSCH, Sounding Reference Signal (SRS), Channel State Information-Reference Signal (CSI-RS), transport block, an active UL BWP change, and an active DL BWP change.

In some embodiment, the network device 110 may transmit, to the terminal device 120, a configuration indicating the first PDCCH candidate and the second PDCCH candidate are linked together for PDCCH repetition. For example, the configuration can be transmitted from the network device 110 to the terminal device 120 via any of the following: Radio Resource Control (RRC) signaling, Medium Access Control (MAC) control element (CE) or DCI. For example, the first PDCCH candidate and the second PDCCH candidate can be used to carry a single or a same DCI format (or DCI payload).

At block 220, in response to a predetermined condition being satisfied, the terminal device 120 detects, from at least one of the first and second PDCCH candidates, DCI comprising a BWP indicator field indicating an active BWP change. In some embodiments, the predetermined condition may be that at least one of the first and second PDCCH candidates is within the first 3 symbols in a slot. In some embodiments, the predetermined condition may be that both of the first and second PDCCH candidates are within the first 3 symbols in a slot.

In some embodiments, the first PDCCH candidate may end no later or earlier than the second PDCCH candidate in time domain.

In some embodiments, for the first and second PDCCH candidates linked or associated with each other, if the DCI format detected in at least one of the first and second PDCCH candidates indicates an active UL or DL BWP change, at least one of the first and second PDCCH candidates is expected to be within the first 3 symbols in a slot.

In some embodiments, at least the earlier PDCCH candidate or at least the PDCCH candidate that ends earlier in time domain is expected to be within the first 3 symbols in a slot. In some embodiments, a UE expects to detect a DCI format with a BWP indicator field that indicates an active UL BWP change or an active DL BWP change only if at least one corresponding PDCCH (or at least the corresponding PDCCH in the first/earlier PDCCH candidate or at least the corresponding PDCCH in the PDCCH candidate that ends earlier in time domain) is received within the first 3 symbols of a slot when the corresponding PDCCH is received in a PDCCH candidate which is linked with another PDCCH candidate. Otherwise, a UE expects to detect a DCI format with a BWP indicator field that indicates an active UL BWP change or an active DL BWP change only if a corresponding PDCCH is received within the first 3 symbols of a slot. In some embodiments, both the first PDCCH candidate and the second PDCCH candidate are within the first 3 symbols or end no later than the 3^{rd} symbol in a same slot. In some embodiments, the first PDCCH candidate may be within the first 3 symbols or ends no later than the 3^{rd} symbol in a first slot, and the second PDCCH candidate may be within the first 3 symbols or ends no later than the 3^{rd} symbol in a second slot. For example, the first slot may be different from or earlier than the second slot. In some embodiments, the first PDCCH candidate may be within the first 3 symbols or ends no later than the 3^{rd} symbol in a first slot, and the second PDCCH candidate may be not within the first 3 symbols or ends later than the 3^{rd} symbol, where the second PDCCH candidate s in the first slot or in a second slot. For example, the second slot may be different from or later than the first slot.

In some embodiments, at least the later PDCCH candidate or at least the PDCCH candidate that ends later in time domain is expected to be within the first 3 symbols in a slot. In some embodiments, a UE expects to detect a DCI format with a BWP indicator field that indicates an active UL BWP change or an active DL BWP change only if at least one corresponding PDCCH (or at least the corresponding PDCCH in the second/later PDCCH candidate or at least the corresponding PDCCH in the PDCCH candidate that ends later in time domain) is received within the first 3 symbols of a slot when the corresponding PDCCH is received in a PDCCH candidate which is linked with another PDCCH candidate. Otherwise, a UE expects to detect a DCI format with a BWP indicator field that indicates an active UL BWP change or an active DL BWP change only if a corresponding PDCCH is received within the first 3 symbols of a slot. In some embodiments, both the first PDCCH candidate and the second PDCCH candidate are within the first 3 symbols or end no later than the 3^{rd} symbol in a same slot. In some embodiments, the first PDCCH candidate may be within the first 3 symbols or ends no later than the 3^{rd} symbol in a first slot, and the second PDCCH candidate may be within the first 3 symbols or ends no later than the 3^{rd} symbol in a second slot. For example, the first slot may be different from or earlier than the second slot. In some embodiments, the first PDCCH candidate may be not within the first 3 symbols or ends later than the third symbol in a first slot, and the second PDCCH candidate may be within the first 3 symbols or ends no later than the 3^{rd} symbol of the first slot or a second slot. For example, the second slot may be different from or later than the first slot.

In some embodiments, for the first and second PDCCH candidates linked together, if the DCI format in the first and second PDCCH candidates indicates an active UL or DL BWP change, at least one of the first and second PDCCH candidates, for example, at least the earlier PDCCH candidate or at least the PDCCH candidate that ends earlier, is expected to be within the first 3 symbols in a slot. That is, a UE expects to detect a DCI format with a BWP indicator field that indicates an active UL BWP change or an active DL BWP change only if at least one corresponding PDCCH (or at least the corresponding PDCCH in the first/earlier PDCCH candidate) is received within the first 3 symbols of a slot when the corresponding PDCCH is received in a PDCCH candidate which is linked with another PDCCH candidate. Otherwise, a UE expects to detect a DCI format with a BWP indicator field that indicates an active UL BWP change or an active DL BWP change only if a corresponding PDCCH is received within the first 3 symbols of a slot.

FIG. 3A illustrates an example of such embodiments. FIG. 3A illustrates PDCCH candidates 310 and 320, which are linked together for PDCCH repetition. The PDCCH candidate 310 is within the first 3 symbols of a lot, while the PDCCH candidate 320 is after the 3^{rd} symbol of the slot. In this event, the terminal device 120 may detect, from at least one of the candidates 310 and 320, a DCI format with a BWP indicator field indicating an active UL or DL BWP change/switching.

Alternatively, in some embodiments, for the first and second PDCCH candidates linked together, if the DCI format in the first and second PDCCH candidates indicates an active UL or DL BWP change, both of the first and second PDCCH candidates expected to be within the first 3 symbols in a slot.

FIG. 3B illustrates an example of such embodiments. FIG. 3B illustrates PDCCH candidates 330 and 340, which are linked together for PDCCH repetition. As shown in FIG. 3B, both of the PDCCH candidates 330 and 340 are within the first 3 symbols of a lot. In this event, the terminal device 120 may detect, from at least one of the candidates 330 and 340, a DCI format with a BWP indicator field indicating an active UL or DL BWP change/switching.

In some embodiments, in case that if a detected DCI format in at least one of the first and second PDCCH candidates includes a BWP indicator field that indicates an active BWP change (for example, an active UL BWP change or an active DL BWP change), the terminal device 120 may determine a reference PDCCH candidate from the first and second PDCCH candidates and determine a time duration or a starting position of the time duration or an ending position of the time duration based on the reference PDCCH candidate. For example, the terminal device 120 is not required to perform any transmission or reception in the time duration. For another example, the terminal device 120 is not required to perform any transmission or reception except receiving any of the first and second PDCCH candidates in the time duration. For another example, the terminal device 120 is not required to perform any transmission or reception except receiving the second PDCCH candidate (that is, the PDCCH candidate ends later in time domain).

In some embodiments, in case that the first and second PDCCH candidates linked together are used to carry a DCI format with a BWP indicator field that indicates an active BWP change, the terminal device 120 may determine a reference PDCCH candidate from the first and second PDCCH candidates and determine, based on the reference PDCCH candidate, a time duration in which the terminal device 120 is not required to perform any transmission or reception except receiving any of the first and second PDCCH candidates.

In some embodiments, in response to the first PDCCH candidate ending earlier than or no later than the second PDCCH candidate, the terminal device 120 may determine the first PDCCH candidate as the reference PDCCH candidate. In some embodiments, the terminal device 120 may determine the time duration starting from an end of a predetermined symbol (for example, the 3^{rd} symbol) of a first slot where the terminal device 120 receives the first PDCCH candidate that includes the DCI format until a beginning of a second slot indicated by a slot offset value of a time domain resource assignment field in the DCI format. For example, during the time duration, the terminal device 120 is not required to perform transmission or reception excepting receiving the second PDCCH candidate (that is, the PDCCH candidate ends later in time domain). For another example, during the time duration, the terminal device 120 is not required to perform any transmission or reception.

In some embodiments, a DCI format detected from at least one of the first and second PDCCH candidates may comprise a time domain resource assignment field indicating a scheduling offset W, where W is an integer. For example 0≤W≤32. In some embodiments, there may be a BWP switch delay Y in case of an active UL BWP change or an active DL BWP change, where Y is an integer. For example, 1≤Y≤18. For another example, Y∈{1, 2, 3, 5, 6, 9, 18}. For another example, Y is the same as T_{BWPswitchDelay} as specified in TS 38.133 of 3GPP specifications. For example, Y may be predetermined or configured via at least one of RRC, MAC CE and DCI. In some embodiments, if a DCI format indicates a scheduling offset W and an active UL BWP or DL BWP change, the value of W should be no smaller than the value of Y, that is, W≥Y.

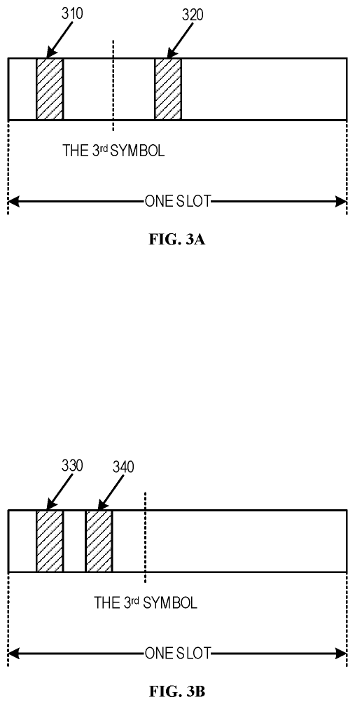

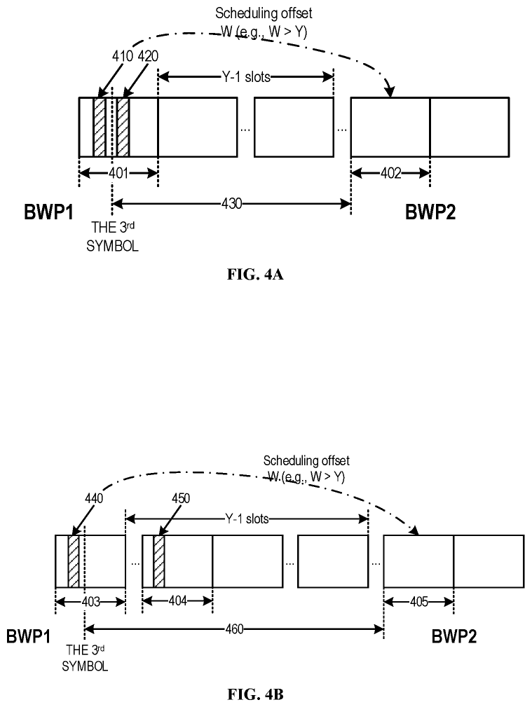

FIG. 4A illustrates an example of such embodiments. FIG. 4A shows PDCCH candidates 410 and 420 linked together for PDCCH repetition. The PDCCH candidates 410 and 420 are used to carry a DCI format comprising a BWP indicator field indicating an active UL or DL BWP change, for example, changing from BWP1 to BWP2. The DCI format may also comprise a time domain resource assignment field indicating a scheduling offset W (where W is an integer, for example, 0≤W≤32), which is greater or equal to the value of a BWP switch delay Y (where Y is an integer). For example, 1≤Y≤18. For another example, Y∈{1, 2, 3, 5, 6, 9, 18}. For another example, Y is the same as T_{BWP-switchDelay} as specified in TS 38.133 of 3GPP specifications. As shown in FIG. 4A, both of the PDCCH candidates 410 and 420 are in a same slot 401 (for example, slot n), where the PDCCH candidate 420 ends later than the PDCCH candidate 410. In this case, a time duration 430 may be determined to start from an end of the 3^{rd} symbol of the slot 401 until the beginning of a slot 402 (for example, slot n+W) indicated by the scheduling offset. For example, during the time duration 430, the terminal device 120 is not required to perform transmission or reception excepting receiving the PDCCH candidate 420. For another example, during the time duration 430, the terminal device 120 is not required to perform any transmission or reception.

FIG. 4B illustrates another example of such embodiments. FIG. 4B shows PDCCH candidates 440 and 450 linked together for PDCCH repetition. The PDCCH candidates 440 and 450 are used to carry a DCI format comprising a BWP indicator field indicating an active UL or DL BWP change, for example, changing from BWP1 to BWP2. The DCI format may also comprise a time domain resource assignment field indicating a scheduling offset W, which exceeds the value of a BWP switch delay Y (for example, T_{BWP-switchDelay} as specified in TS 38.133 of 3GPP specifications). As shown in FIG. 4B, the PDCCH candidate 440 is in a slot 403 (for example, slot n) and the PDCCH candidate 450 is in a later slot 404 (for example, slot n+k). In this case, a time duration 460 may be determined to start from an end of the 3^{rd} symbol of the slot 403 until the beginning of a slot 405 (for example, slot n+W) indicated by the scheduling offset. For example, during the time duration 460, the terminal device 120 is not required to perform transmission or reception excepting receiving the PDCCH candidate 450. For another example, during the time duration 460, the terminal device 120 is not required to perform any transmission or reception.

In some embodiments, in response to the first PDCCH candidate ending earlier than or no later than the second PDCCH candidate, the terminal device 120 may determine the second PDCCH candidate as the reference PDCCH candidate. In some embodiments, the terminal device 120 may determine the time duration starting from an end of a predetermined symbol (for example, the 3^{rd} symbol) of a first slot where the terminal device 120 receives the second PDCCH candidate that includes the DCI format until a beginning of a second slot indicated by a slot offset value of a time domain resource assignment field in the DCI format. For example, during the time duration, the terminal device 120 is not required to perform transmission or reception excepting receiving the second PDCCH candidate (that is, the PDCCH candidate ends later). For another example, during the time duration, the terminal device 120 is not required to perform any transmission or reception.

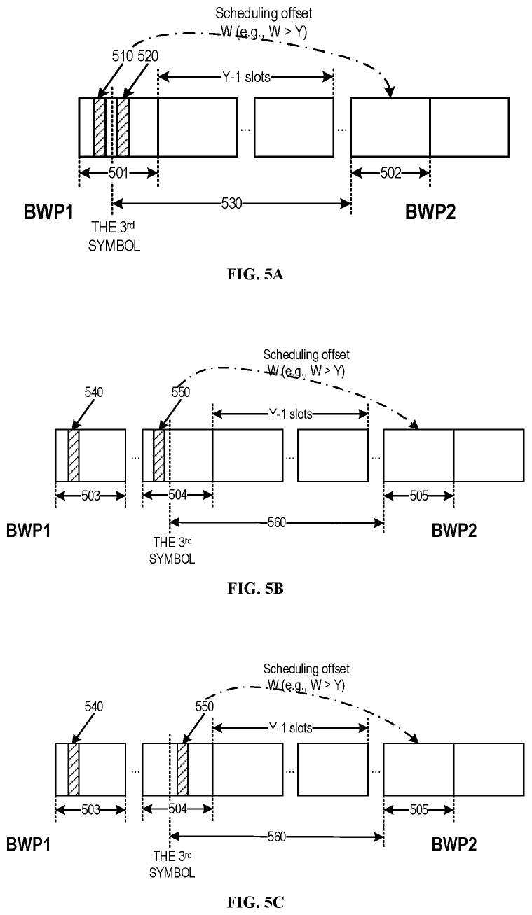

FIG. 5A illustrates an example of such embodiments. FIG. 5A shows PDCCH candidates 510 and 520 linked together for PDCCH repetition. The PDCCH candidates 510 and 520 are used to carry a DCI format comprising a BWP indicator field indicating an active UL or DL BWP change, for example, changing from BWP1 to BWP2. The DCI format may also comprise a time domain resource assignment field indicating a scheduling offset W, which exceeds the value of a BWP switch delay Y (for example, T_{BWPswitchDelay} as specified in TS 38.133 of 3GPP specifications). As shown in FIG. 5A, both of the PDCCH candidates 510 and 520 are in a same slot 501 (for example, slot n), where the PDCCH candidate 520 ends later than or no earlier than the PDCCH candidate 510. In this case, a time duration 530 may be determined to start from an end of the 3^{rd} symbol of the slot 501 until the beginning of a slot 502 (for example, slot n+W) indicated by the scheduling offset. For example, during the time duration 530, the terminal device 120 is not required to perform transmission or reception excepting receiving the PDCCH candidate 520. For another example, during the time duration 530, the terminal device 120 is not required to perform any transmission or reception.

FIG. 5B and FIG. 5C illustrate another example of such embodiments. FIG. 5B and FIG. 5C show PDCCH candidates 540 and 550 linked together for PDCCH repetition. The PDCCH candidates 540 and 550 are used to carry a DCI format comprising a BWP indicator field indicating an active UL or DL BWP change, for example, changing from field indicating a scheduling offset W, which exceeds the value of a BWP switch delay Y (for example, T_{BWPswitchDelay} as specified in TS 38.133 of 3GPP specifications). As shown in FIG. 5B and FIG. 5C, the PDCCH candidate 540 is in a slot 503 (for example, slot n) and the PDCCH candidate 550 is in a later slot 504 (for example, slot n+k). In FIG. 5B, the PDCCH candidate 550 may be within the first 3 symbols in the slot 504. In FIG. 5C, the PDCCH candidate 550 may be after the first 3 symbols in the slot 504. In this case, as shown in FIG. 5B and FIG. 5C, a time duration 560 may be determined to start from an end of the 3^{rd} symbol of the slot 503 until the beginning of a slot 505 (for example, slot n+k+W) indicated by the scheduling offset. For example, during the time duration 560, the terminal device 120 is not required to perform transmission or reception excepting receiving the PDCCH candidate 550. For another example, during the time duration 560, the terminal device 120 is not required to perform any transmission or reception.

In some embodiments, in response to the first PDCCH candidate ending earlier than or no later than the second PDCCH candidate, the terminal device 120 may determine the second PDCCH candidate as the reference PDCCH candidate. In some embodiments, the terminal device 120 may determine the time duration starting from an end of a last symbol for the second PDCCH candidate until a beginning of a second slot, wherein the second slot is indicated by a slot offset comprised in the DCI. For example, during the time duration, the terminal device 120 is not required to perform transmission or reception excepting receiving the second PDCCH candidate (that is, the PDCCH candidate ends later). For another example, during the time duration, the terminal device 120 is not required to perform any transmission or reception.

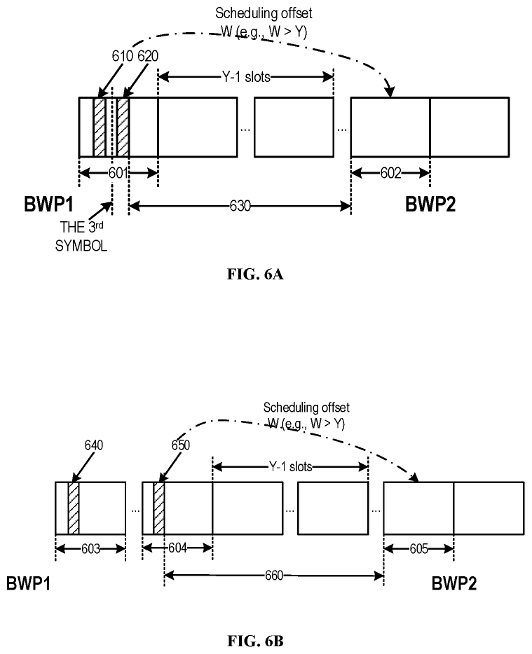

FIG. 6A illustrates an example of such embodiments. FIG. 6A shows PDCCH candidates 610 and 620 linked together for PDCCH repetition. The PDCCH candidates 610 and 620 are used to carry a DCI format comprising a BWP indicator field indicating an active UL or DL BWP change, for example, changing from BWP1 to BWP2. The DCI format may also comprise a time domain resource assignment field indicating a scheduling offset W, which exceeds the value of a BWP switch delay Y (for example, T_{BWPswitchDelay} as specified in TS 38.133 of 3GPP specifications). As shown in FIG. 6A, both of the PDCCH candidates 610 and 620 are in a same slot 601 (for example, slot n), where the PDCCH candidate 620 ends later than or no earlier than the PDCCH candidate 610. In this case, a time duration 630 may be determined to start from an end of the last symbol for the PDCCH candidate 620 until the beginning of a slot 602 (for example, slot n+W) indicated by the scheduling offset. For example, during the time duration 630, the terminal device 120 is not required to perform transmission or reception.

FIG. 6B illustrates another example of such embodiments. FIG. 6B shows PDCCH candidates 640 and 650 linked together for PDCCH repetition. The PDCCH candidates 640 and 650 are used to carry a DCI format comprising a BWP indicator field indicating an active UL or DL BWP change, for example, changing from BWP1 to BWP2. The DCI format may also comprise a time domain resource assignment field indicating a scheduling offset W, which exceeds the value of a BWP switch delay Y (for example, T_{BWP-switchDelay} as specified in TS 38.133 of 3GPP specifications). As shown in FIG. 6B, the PDCCH candidate 640 is in a slot 603 (for example, slot n) and the PDCCH candidate 650 is in a later slot 604 (for example, slot n+k). In this case, a time duration 660 may be determined to start from an end of the last symbol for the PDCCH candidate 650 until the beginning of a slot 605 (for example, slot n+k+W) indicated by the scheduling offset. For example, during the time duration 660, the terminal device 120 is not required to perform transmission or reception.

In some embodiments, in response to the first PDCCH candidate ending earlier than or no later than the second PDCCH candidate, the terminal device 120 may determine the second PDCCH candidate as the reference PDCCH candidate. In some embodiments, the second PDCCH candidate may be in a third slot. In response to a predetermined symbol (for example, the 3^{rd} symbol) of the third slot ending later than a last symbol for the second PDCCH candidate, the terminal device 120 may determine the time duration starting from an end of the predetermined symbol (that is, the 3^{rd} symbol) of the third slot until a beginning of a second slot, where the second slot is indicated by a slot offset comprised in the DCI. In response to the predetermined symbol (for example, the 3^{rd} symbol) of the third slot ending no later than the last symbol for the second PDCCH candidate, the terminal device 120 may determine the time duration starting from an end of the last symbol for the second PDCCH candidate until a beginning of a second slot, where the second slot is indicated by a slot offset comprised in the DCI.

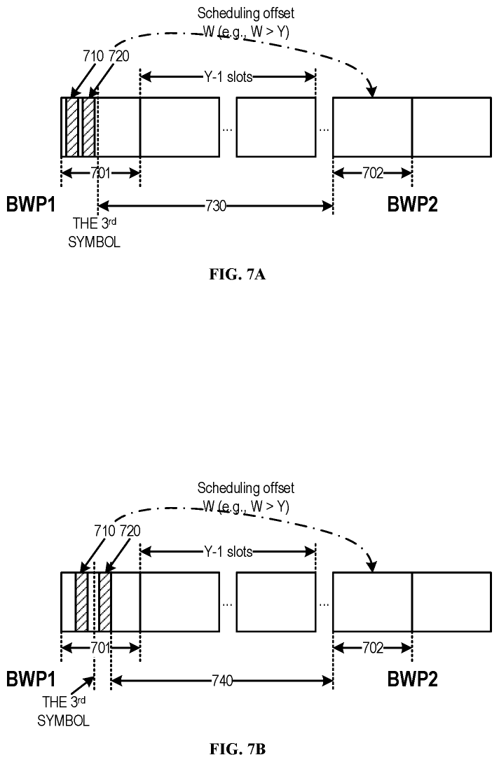

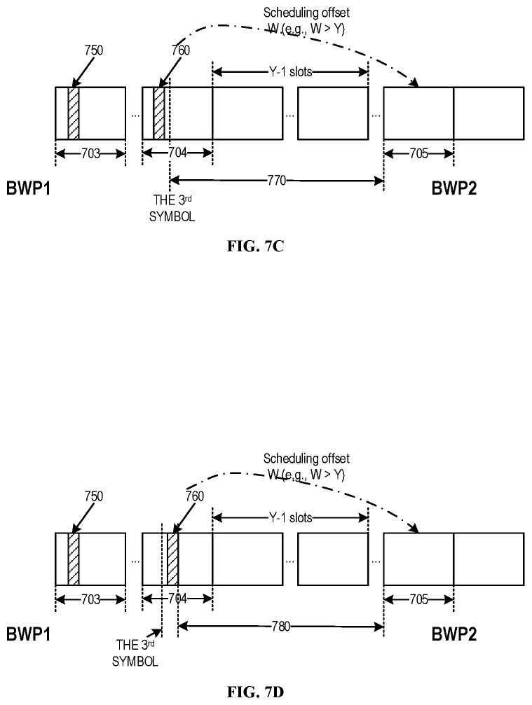

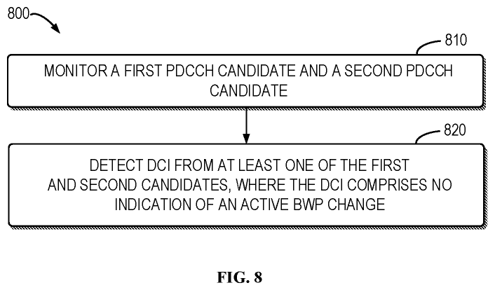

FIG. 7A and FIG. 7B illustrate examples of such embodiments. FIG. 7A and FIG. 7B show PDCCH candidates 710 and 720 linked together for PDCCH repetition. The PDCCH candidates 710 and 720 are used to carry a DCI format comprising a BWP indicator field indicating an active UL or DL BWP change, for example, changing from field indicating a scheduling offset W, which exceeds the value of a BWP switch delay Y (for example, T_{BWPswitchDelay} as specified in TS 38.133 of 3GPP specifications). Both of the PDCCH candidates 710 and 720 are in a same slot 701 (for example, slot n), where the PDCCH candidate 720 ends later than or no earlier than the PDCCH candidate 710. In FIG. 7A, the 3^{rd} symbol of the slot 701 ends later than the last symbol for the PDCCH candidate 720. In this case, a time duration 730 may be determined to start from an end of the 3^{rd} symbol of the slot 701 until the beginning of a slot 702 (for example, slot n+W) indicated by the scheduling offset. For example, during the time duration 730, the terminal device 120 is not required to perform transmission or reception. In FIG. 7B, the 3^{rd} symbol of the slot 701 ends earlier than the last symbol for the PDCCH candidate 720. In this case, a time duration 740 may be determined to start from an end of the last symbol for the PDCCH candidate 720 until the beginning of the slot 702 (that is, slot n+W) indicated by the scheduling offset. For example, during the time duration 740, the terminal device 120 is not required to perform transmission or reception.

FIG. 7C and FIG. 7D illustrate other examples of such embodiments. FIG. 7C and FIG. 7D show PDCCH candidates 750 and 760 linked together for PDCCH repetition. The PDCCH candidates 750 and 760 are used to carry a DCI format comprising a BWP indicator field indicating an active UL or DL BWP change, for example, changing from BWP1 to BWP2. The DCI format may also comprise a time domain resource assignment field indicating a scheduling offset W, which exceeds the value of a BWP switch delay Y (for example, T_{BWPswitchDelay} as specified in TS 38.133 of 3GPP specifications). The PDCCH candidate 750 is in a slot 703 (for example, slot n) and the PDCCH candidate 760 is in a later slot 704 (for example, slot n+k). In FIG. 7C, the 3^{rd} symbol of the slot 704 ends later than or no earlier than the last symbol for the PDCCH candidate 760. In this case, a time duration 770 may be determined to start from an end of the 3^{rd} symbol of the slot 704 until the beginning of a slot 705 (for example, slot n+k+W) indicated by the scheduling offset. For example, during the time duration 770, the terminal device 120 is not required to perform transmission or reception. In FIG. 7D, the 3^{rd} symbol of the slot 704 ends earlier than or no later than the last symbol for the PDCCH candidate 760. In this case, a time duration 780 may be determined to start from an end of the last symbol for the PDCCH candidate 760 until the beginning of the slot 705 (that is, slot n+k+W) indicated by the scheduling offset. For example, during the time duration 780, the terminal device 120 is not required to perform transmission or reception.

In some embodiments, in case that the first and second PDCCH candidates linked together are used to carry a DCI format with a BWP indicator field that indicates an active BWP change, the terminal device 120 may determine a reference PDCCH candidate from the first and second PDCCH candidates and determine, based on the reference PDCCH candidate, a time duration in which the terminal device 120 is not required to perform any transmission or reception except receiving any of the first and second PDCCH candidates.

In some embodiments, there may be a further time duration in which a terminal device is not required to perform reception or transmission. For example, the further time duration may be determined based on at least one of the following: an active DL BWP change indicated by a DCI format, an active UL BWP change indicated by a DCI format, an active DL BWP change for a secondary cell (Scell) indicated by an Scell dormancy indication, an active DL BWP change due to a BWP inactivity timer expiration and an active UL BWP change due to a BWP inactivity timer expiration.

In some embodiments, in response to a third PDCCH candidate and a fourth PDCCH candidate being linked for PDCCH repetition and one of the third and fourth PDCCH candidates overlapping with the time duration or the further time duration, the terminal device 120 may drop both of the third and fourth PDCCH candidates. For example, in this case, the terminal device 120 may monitor none of the third and fourth PDCCH candidates. Alternatively, in some embodiments, in response to a third PDCCH candidate and a fourth PDCCH candidate being linked for PDCCH repetition and the fourth PDCCH candidate overlapping with the time duration or the further time duration, the terminal device 120 may drop the fourth PDCCH candidate. For example, the terminal device 120 may monitor the third PDCCH candidate without monitoring the fourth PDCCH candidate. Alternatively, in some embodiments, in response to a third PDCCH candidate and a fourth PDCCH candidate being linked for PDCCH repetition and the fourth PDCCH candidate overlapping with the time duration or the further time duration, the terminal device 120 may disable soft-combing of the third and fourth PDCCH candidates. That is, the terminal device 120 may fallback to single PDCCH candidate monitoring.

In some embodiments, if a first PDCCH candidate and a second PDCCH candidate are linked together for PDCCH repetition, the terminal device 120 is not expected to receive an active BWP switching/change indication in the corresponding PDCCH from at least one of the first PDCCH candidate and the second PDCCH candidate. In some embodiments, an active BWP switching/change indication may indicate an active UL BWP switching/change or an active DL BWP switching/change.

In some embodiments, the terminal device 120 may ignore the BWP indicator field in the detected DCI from at least one of the first PDCCH candidate and the second PDCCH candidate. In some embodiments, there is no BWP indicator field in the DCI in at least one of the first PDCCH candidate and the second PDCCH candidate.

In some embodiments, if a first PDCCH candidate and a second PDCCH candidate are linked together for PDCCH repetition, there is no BWP indicator field in the DCI from at least one of the first PDCCH candidate and the second PDCCH candidate.

In some embodiments, if a first PDCCH candidate and a second PDCCH candidate are linked together for PDCCH repetition, and if there is BWP indicator field in the DCI from at least one of the first PDCCH candidate and the second PDCCH candidate, the field is used to indicate other scheduling information. For example, the other scheduling information may indicate multi-TRP or single TRP transmission or a TRP index.

FIG. 8 illustrates a flowchart of an example method 800 in accordance with some embodiments of the present disclosure. For example, the method 800 can be implemented at the terminal device 120 as shown in FIG. 1.

At block 810, the terminal device 120 monitors a first PDCCH candidate and a second PDCCH candidate, wherein the first PDCCH candidate and the second PDCCH candidate are linked for PDCCH repetition. At block 820, the terminal device 120 detects DCI from at least one of the first and second PDCCH candidates, wherein the DCI comprises no indication of an active BWP change.

In some embodiments, the DCI may comprise no BWP indicator field. Alternatively, a BWP indicator field in the DCI may comprise no active BWP switching indication. Alternatively, a BWP indicator field in the DCI may be ignored by the terminal device 120.

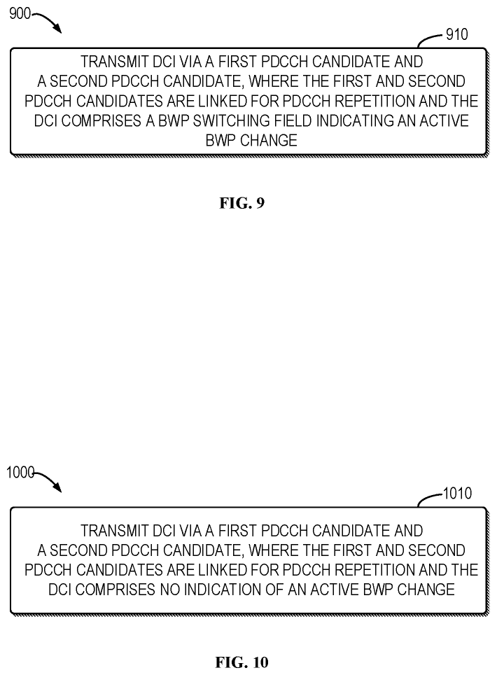

FIG. 9 illustrates a flowchart of an example method 900 in accordance with some embodiments of the present disclosure. For example, the method 900 can be implemented at the network device 110 as shown in FIG. 1.

At block 910, the network device 110 transmits, to a terminal device, DCI via a first PDCCH candidate and a second PDCCH candidate, wherein the first PDCCH candidate and the second PDCCH candidate are linked for PDCCH repetition and the DCI comprises a BWP indicator field indicating an active BWP change.

In some embodiments, at least one of the first and second PDCCH candidates comprising the DCI is transmitted within the first predetermined number of symbols in a slot.

In some embodiments, both of the first and second PDCCH candidates comprising the DCI are transmitted within the first predetermined number of symbols in a slot.

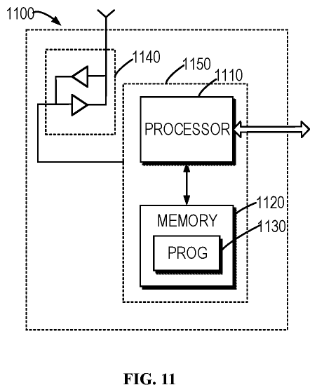

FIG. 10 illustrates a flowchart of an example method 1000 in accordance with some embodiments of the present disclosure. For example, the method 1000 can be implemented at the network device 110 as shown in FIG. 1.

At block 1010, the network device 110 transmits, to a terminal device, DCI via a first PDCCH candidate and a second PDCCH candidate, wherein the first PDCCH candidate and the second PDCCH candidate are linked for PDCCH repetition and the DCI comprises no indication of an active BWP change.

In some embodiments, the DCI comprises no BWP indicator field. Alternatively, a BWP indicator field in the DCI comprises no indication of an active BWP change.

In some embodiments, a terminal device comprises circuitry configured to: monitor a first PDCCH candidate and a second PDCCH candidate, wherein the first PDCCH candidate and the second PDCCH candidate are linked for PDCCH repetition; and in response to a predetermined condition being satisfied, detect, from at least one of the first and second PDCCH candidates, DCI comprising a BWP indicator field indicating an active BWP change.

In some embodiments, the terminal device comprises circuitry configured to: in response to at least one of the first and second PDCCH candidates being received within the first predetermined number of symbols in a slot, detect, from at least one of the first and second PDCCH candidates, the DCI comprising the BWP indicator field indicating an active BWP change.

In some embodiments, the terminal device comprises circuitry configured to: in response to both of the first and second PDCCH candidates being received within the first predetermined number of symbols in a slot, detect, from at least one of the first and second PDCCH candidates, the DCI comprising the BWP indicator field indicating an active BWP change.

In some embodiments, the terminal device comprises circuitry configured to: determine, from the first and second PDCCH candidates, a reference PDCCH candidate; and determine, based on the reference PDCCH candidate, a time duration in which the terminal device is not required to perform any transmission or reception except receiving any of the first and second PDCCH candidates.

In some embodiments, the terminal device comprises circuitry configured to: in response to the first PDCCH candidate ending earlier than the second PDCCH candidate, determine the first PDCCH candidate as the reference PDCCH candidate.

In some embodiments, the terminal device comprises circuitry configured to: in response to the first PDCCH candidate ending earlier than the second PDCCH candidate, determine the second PDCCH candidate as the reference PDCCH candidate.

In some embodiments, the terminal device comprises circuitry configured to: determine the time duration starting from an end of a predetermined symbol of a first slot until a beginning of a second slot, wherein the reference PDCCH candidate comprising the DCI is received in the first slot and the second slot is indicated by a slot offset comprised in the DCI.

In some embodiments, the terminal device comprises circuitry configured to: determine the time duration starting from an end of a last symbol for the second PDCCH candidate until a beginning of a second slot, wherein the second slot is indicated by a slot offset comprised in the DCI.

In some embodiments, the second PDCCH candidate is received in a third slot, and the terminal device comprises circuitry configured to: in response to a predetermined symbol of the third slot ending later than a last symbol for the second PDCCH candidate, determine the time duration starting from an end of the predetermined symbol of the third slot until a beginning of a second slot; and in response to the predetermined symbol of the third slot ending no later than the last symbol for the second PDCCH candidate, determine the time duration starting from an end of the last symbol for the second PDCCH candidate until the beginning of the second slot, wherein the second slot is indicated by a slot offset comprised in the DCI.

In some embodiments, the terminal device comprises circuitry configured to: in response to a third PDCCH candidate and a fourth PDCCH candidate being linked for PDCCH repetition and one of the third and fourth PDCCH candidates overlapping with the time duration, monitor none of the third and fourth PDCCH candidates.

In some embodiments, the terminal device comprises circuitry configured to: in response to a third PDCCH candidate and a fourth PDCCH candidate being linked for PDCCH repetition and the fourth PDCCH candidate overlapping with the time duration, monitor the third PDCCH candidate without monitoring the fourth PDCCH candidate.

In some embodiments, the terminal device comprises circuitry configured to: in response to a third PDCCH candidate and a fourth PDCCH candidate being linked for PDCCH repetition and one of the third and fourth PDCCH candidates overlapping with the time duration, disable soft-combing of the third and fourth PDCCH candidates.

In some embodiments, a terminal device comprises circuitry configured to: monitor a first PDCCH candidate and a second PDCCH candidate, wherein the first PDCCH candidate and the second PDCCH candidate are linked for PDCCH repetition; and detect DCI from at least one of the first and second PDCCH candidates, wherein the DCI comprises no indication of an active BWP change.

In some embodiments, the DCI comprises no BWP indicator field. Alternatively, a BWP indicator field in the DCI comprises no indication of an active BWP change. Alternatively, the BWP indicator field in the DCI is ignored by the terminal device.

In some embodiments, a network device comprises circuitry configured to: transmit, to a terminal device, DCI via a first PDCCH candidate and a second PDCCH candidate, wherein the first PDCCH candidate and the second PDCCH candidate are linked for PDCCH repetition and the DCI comprises a BWP indicator field indicating an active BWP change.

In some embodiments, at least one of the first and second PDCCH candidates comprising the DCI is transmitted within the first predetermined number of symbols in a slot.

In some embodiments, both of the first and second PDCCH candidates comprising the DCI are transmitted within the first predetermined number of symbols in a slot.

In some embodiments, a network device comprises circuitry configured to: transmit, to a terminal device, DCI via a first PDCCH candidate and a second PDCCH candidate, wherein the first PDCCH candidate and the second PDCCH candidate are linked for PDCCH repetition and the DCI comprises no indication of an active BWP change.

In some embodiments, the DCI comprises no BWP indicator field. Alternatively, a BWP indicator field in the DCI comprises no indication of an active BWP change.

FIG. 11 is a simplified block diagram of a device 1100 that is suitable for implementing embodiments of the present disclosure. The device 1100 can be considered as a further example implementation of the network device 110 and/or the terminal device 120 as shown in FIG. 1. Accordingly, the device 1100 can be implemented at or as at least a part of the network device 110 and/or the terminal device 120 as shown in FIG. 1.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2, 8-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-23. (canceled)

24. A method of communication, comprising:
monitoring, at a terminal device, a first Physical Downlink Control Channel (PDCCH) candidate and a second PDCCH candidate, wherein the first PDCCH candidate and the second PDCCH candidate are linked for PDCCH repetition; and
in response to a predetermined condition being satisfied, detecting, from at least one of the first and second PDCCH candidates, downlink control information (DCI) comprising a bandwidth part (BWP) indicator field indicating an active BWP change.

25. The method of claim 24, wherein detecting the DCI comprises:
in response to at least one of the first and second PDCCH candidates being received within the first predetermined number of symbols in a slot,
detecting, from at least one of the first and second PDCCH candidates, the DCI comprising the BWP indicator field indicating an active BWP change.

26. The method of claim 24, wherein detecting the DCI comprises:
in response to both of the first and second PDCCH candidates being received within the first predetermined number of symbols in a slot,
detecting, from at least one of the first and second PDCCH candidates, the DCI comprising the BWP indicator field indicating an active BWP change.

27. The method of claim 24, further comprising:
determining, from the first and second PDCCH candidates, a reference PDCCH candidate; and
determining, based on the reference PDCCH candidate, a time duration in which the terminal device is not required to perform any transmission or reception except receiving any of the first and second PDCCH candidates.

28. The method of claim 27, wherein determining the reference PDCCH candidate comprises:
in response to the first PDCCH candidate ending earlier than the second PDCCH candidate, determining the first PDCCH candidate as the reference PDCCH candidate.

29. The method of claim 27, wherein determining the reference PDCCH candidate comprises:
in response to the first PDCCH candidate ending earlier than the second PDCCH candidate, determining the second PDCCH candidate as the reference PDCCH candidate.

30. The method of claim 27, wherein determining the time duration comprises:
determining the time duration starting from an end of a predetermined symbol of a first slot until a beginning of a second slot,
wherein the reference PDCCH candidate comprising the DCI is received in the first slot and the second slot is indicated by a slot offset comprised in the DCI.

31. The method of claim 29, wherein the second PDCCH candidate is received in a third slot, and determining the time duration comprises:
in response to a predetermined symbol of the third slot ending later than a last symbol for the second PDCCH candidate, determining the time duration starting from an end of the predetermined symbol of the third slot until a beginning of a second slot; and
in response to the predetermined symbol of the third slot ending no later than the last symbol for the second PDCCH candidate, determining the time duration starting from an end of the last symbol for the second PDCCH candidate until the beginning of the second slot,
wherein the second slot is indicated by a slot offset comprised in the DCI.

32. The method of claim 27, further comprising:
in response to a third PDCCH candidate and a fourth PDCCH candidate being linked for PDCCH repetition and one of the third and fourth PDCCH candidates overlapping with the time duration, monitoring none of the third and fourth PDCCH candidates.

33. The method of claim 27, further comprising:
in response to a third PDCCH candidate and a fourth PDCCH candidate being linked for PDCCH repetition and the fourth PDCCH candidate overlapping with the time duration, monitoring the third PDCCH candidate without monitoring the fourth PDCCH candidate.

34. The method of claim 27, further comprising:
in response to a third PDCCH candidate and a fourth PDCCH candidate being linked for PDCCH repetition and one of the third and fourth PDCCH candidates overlapping with the time duration, disabling soft-combing of the third and fourth PDCCH candidates.

35. A method of communication, comprising:
transmitting, from a network device to a terminal device, downlink control information (DCI) via a first Physical Downlink Control Channel (PDCCH) candidate and a second PDCCH candidate,
wherein the first PDCCH candidate and the second PDCCH candidate are linked for PDCCH repetition and the DCI comprises a bandwidth part (BWP) indicator field indicating an active BWP change.

36. The method of claim 35, wherein at least one of the first and second PDCCH candidates comprising the DCI is transmitted within the first predetermined number of symbols in a slot.

37. The method of claim 35, wherein both of the first and second PDCCH candidates comprising the DCI are transmitted within the first predetermined number of symbols in a slot.

38. A terminal device comprising:
at least one processor; and
at least one memory having program instructions stored thereon, the program instructions, when executed by the at least one processor, causing the terminal device to perform a method comprising:
monitoring, at a terminal device, a first Physical Downlink Control Channel (PDCCH) candidate and a second PDCCH candidate, wherein the first PDCCH candidate and the second PDCCH candidate are linked for PDCCH repetition; and
in response to a predetermined condition being satisfied, detecting, from at least one of the first and second PDCCH candidates, downlink control information (DCI) comprising a bandwidth part (BWP) indicator field indicating an active BWP change.

39. The terminal device of claim 38, wherein detecting the DCI comprises:
in response to at least one of the first and second PDCCH candidates being received within the first predetermined number of symbols in a slot,
detecting, from at least one of the first and second PDCCH candidates, the DCI comprising the BWP indicator field indicating an active BWP change.

40. The terminal device of claim 38, wherein detecting the DCI comprises:
in response to both of the first and second PDCCH candidates being received within the first predetermined number of symbols in a slot,
detecting, from at least one of the first and second PDCCH candidates, the DCI comprising the BWP indicator field indicating an active BWP change.

41. The terminal device of claim 38, the method further comprising:
determining, from the first and second PDCCH candidates, a reference PDCCH candidate; and
determining, based on the reference PDCCH candidate, a time duration in which the terminal device is not required to perform any transmission or reception except receiving any of the first and second PDCCH candidates.

42. The terminal device of claim 41, wherein determining the reference PDCCH candidate comprises:
in response to the first PDCCH candidate ending earlier than the second PDCCH candidate, determining the second PDCCH candidate as the reference PDCCH candidate.

43. The terminal device of claim 41, wherein determining the time duration comprises:
determining the time duration starting from an end of a predetermined symbol of a first slot until a beginning of a second slot,
wherein the reference PDCCH candidate comprising the DCI is received in the first slot and the second slot is indicated by a slot offset comprised in the DCI.
